(19) United States
(12) Patent Application Publication
(10) Pub. No.: US 2006/0272473 A1
(43) Pub. Date: Dec. 7, 2006

(54) Mouthpiece for a wind instrument

(76) Inventor: Wen-Hung Kuo, Dali City (TW)

Correspondence Address: BIRCH STEWART KOLASCH & BIRCH, PO BOX 747, FALLS CHURCH, VA, 22040-0747, US

(21) Appl. No.: 11/140,953

(22) Filed: Jun. 1, 2005

(51) Int. Cl. G10D 9/02; G10D 7/00; G10D 9/00

(52) U.S. Cl. 84/383 R

(57) ABSTRACT

A mouthpiece for a wind instrument has a body made of porcelain clay and including a mouth end adapted for contacting with a user's mouth, a connection end and a channel defined through the body and having two openings at the ends of the body. Accordingly, the mouthpiece does not become oxidized and has a smooth inner surface on the channel to improve the timbre of the sound issued from the wind instrument.

### BACKGROUND OF THE INVENTION

1. Field of the Invention

The present invention relates to a mouthpiece, and more particularly to a mouthpiece for a wind instrument and made of porcelain clay.

2. Description of Related Art

Wind instruments, such as trumpets, trombones, French horns, clarinets or saxophones have a mouthpiece to let a user blow air into the wind instruments to generate sound with resonance of the instruments. With reference to FIG. 3, a conventional mouthpiece (50) in accordance with the prior art has a body comprising a channel defined through the body. A connection portion is formed on one end of the body to connect with a corresponding wind instrument.

The conventional mouthpiece (50) is commonly made of plastic material or metal. However, the plastic material is soft, so the sound generating through a conventional plastic mouthpiece (50) is not sufficiently acute for playing some styles of music, especially jazz. In addition, the inner surface of the channel of the conventional plastic mouthpiece (50) is always rough due to bits formed on the inner surface of the channel during the manufacturing process, such that airflow in the channel is not smooth and the sound played by the instrument with the mouthpiece (50) is not good as desired.

The conventional metal mouthpiece is made of copper plated with a silver layer. However, the silver layer easily falls off the copper mouthpiece to cause the mouthpiece to become oxidized after a time of use. Furthermore, coppery ions from the copper mouthpiece easily enter into the mouth of the user and cause the user to become unhealthy.

To overcome the shortcomings, the present invention tends to provide a mouthpiece for wind instruments to mitigate or obviate the aforementioned problems.

### SUMMARY OF THE INVENTION

The main objective of the invention is to provide a mouthpiece for a wind instrument that can improve the timbre of the sound issued from the wind instrument. The mouthpiece for a wind instrument has a body comprising a mouth end adapted for contacting with a user's mouth, a connection end to connect to the wind instrument and a channel defined through the body and having two openings at the ends of the body. The body is made of porcelain clay, such that the body does not become oxidized and has a smooth inner surface on the channel to improve the timbre of the sound issued from the wind instrument.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a mouthpiece in accordance with the present invention with a resonance plate and a plate holder;

FIG. 2 is a side plan view in partial cross section of the mouthpiece with the resonance plate and the plate holder in FIG. 1; and

FIG. 3 is a perspective view of a conventional mouthpiece in accordance with the prior art with a resonance plate and a plate holder.

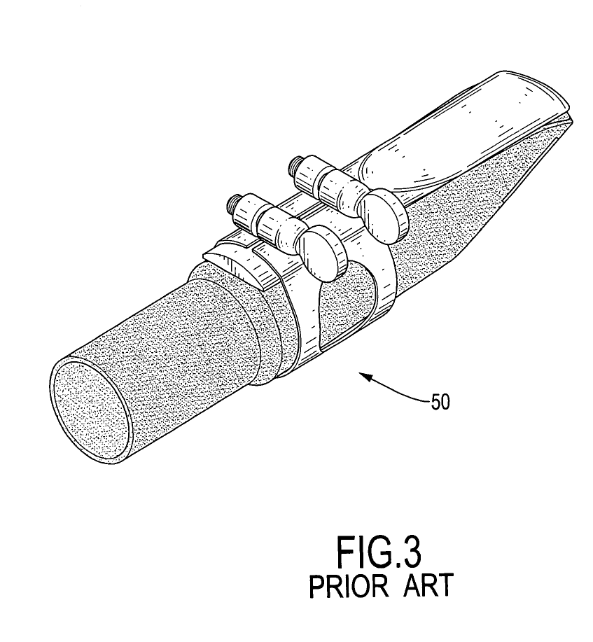

### DETAILED DESCRIPTION OF PREFERRED EMBODIMENT

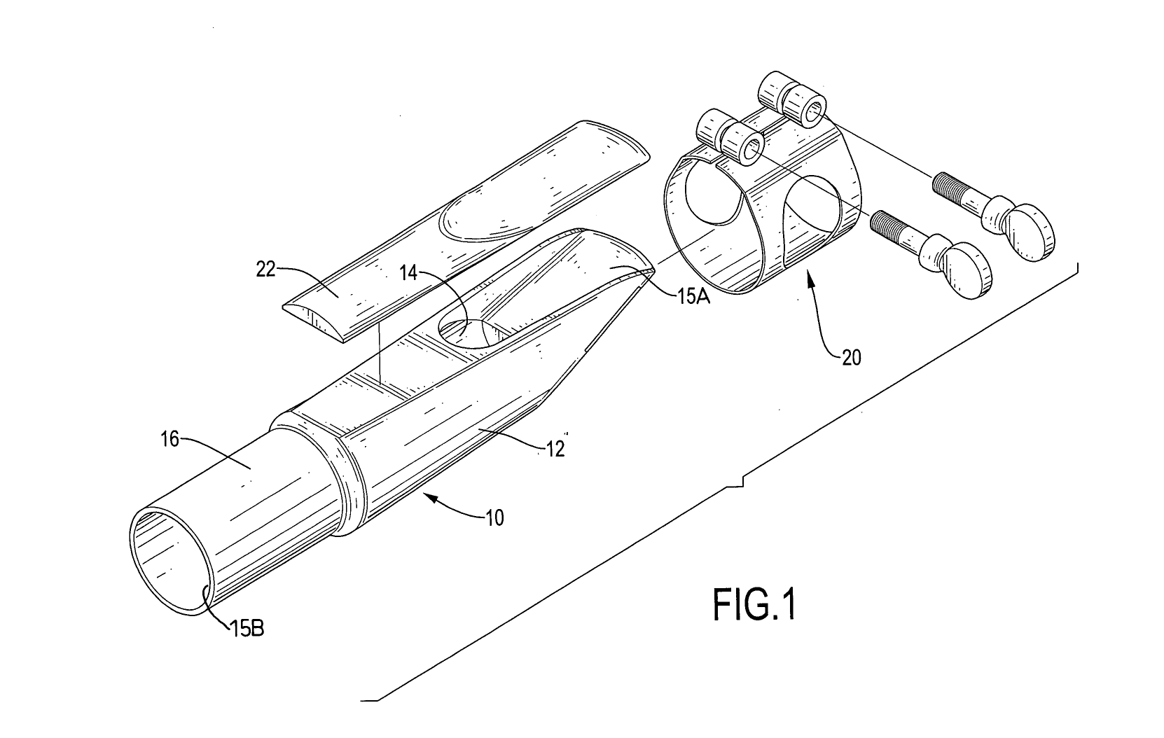

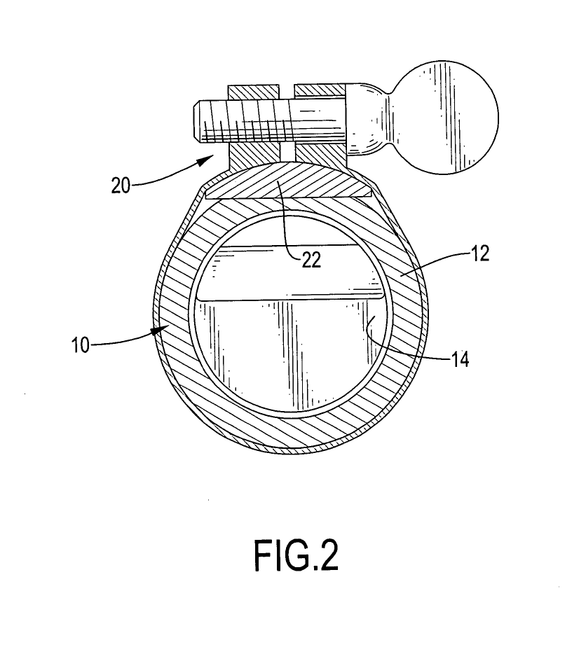

With reference to FIGS. 1 and 2, a mouthpiece (10) for a wind instrument comprises a body (12) made of porcelain clay and having a mouth end, a connection end (16) and a channel (14). The mouth end of the body (12) is adapted for contacting with a user's mouth. The connection end (16) is connected to the wind instrument to enable the mouthpiece (10) to be mounted on the instrument, The channel (14) is defined through the body (12) and has two openings (15A, 15B) at respective ends of the body (12). A resonance plate or reed (22) made of bamboo is attached to the body (12) with a plate holder (20) and corresponds to the opening (15) opposite to the connection end (16). Accordingly, a resonant effect is provided by the resonance plate (22) when a user blows air into the channel (14) through the opening (15).

The characteristics of porcelain clay are such that the mouthpiece (10) has an enough hardness to make the sound played by the instrument with the mouthpiece (10) acute for playing specific music, such as jazz and is versatile in use. In addition, the porcelain mouthpiece (10) has a smooth inner surface on the channel (14) and does not become oxidized, so the airflow in the channel (14) is always smooth and the timbre of sound issued from the instrument is improved. The porcelain mouthpiece (10) in accordance with the present invention does not oxidize, nor does deform after a long time of use, so that the useful life of the mouthpiece (10) is prolonged.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mouthpiece for a wind instrument comprising:
a body comprising a mouth end adapted for contacting with a user's mouth, a connection end to connect to the wind instrument and a channel defined through the body and having two openings at respective ends of the body,
wherein the body is made of porcelain clay.
